(19) United States
(12) Patent Application Publication
(10) Pub. No.: US 2026/0330950 A1
(43) Pub. Date: Oct. 22, 2026

(54) SYSTEMS AND METHODS FOR PERSONAL SECURITY MONITORING

(71) Applicant: Guy J. Acosta, Mesquite, NV (US)

(72) Inventor: Guy J. Acosta, Mesquite, NV (US)

(21) Appl. No.: 19/656,187

(22) Filed: Apr. 23, 2026

Related U.S. Application Data
(63) Continuation of application No. 19/184,696, filed on Apr. 21, 2025.

(51) Int. Cl. G08B 21/02; G10L 15/08

(52) U.S. Cl. CPC G08B 21/0283; G08B 21/0208; G08B 21/0222; G08B 21/0261; G08B 21/0269; G10L 15/08; G10L 2015/088

(57) ABSTRACT

A personal safety monitoring and alerting system enables automated check-ins and emergency notifications based on user-defined rules, safe words, and event triggers. The system comprises a user interface for configuring safety parameters, a monitoring engine that evaluates scheduled or real-time events, and a communications module for sending and receiving safety status messages via SMS, email, or other channels. A response analyzer detects safe words or lack of response, prompting an alert system to transmit emergency messages containing the user's contextual data, including medical information, travel plans, personal identifiers, and designated contact details. The system may further include functionality for post-event data transmission, administrative monitoring, and rule-based escalation, enhancing personal security and emergency response capabilities.

### CROSS-REFERENCE TO RELATED APPLICATIONS

The present application claims priority to U.S. application Ser. No. 19/184,696 filed Apr. 21, 2025, titled “SYSTEMS AND METHODS FOR PERSONAL SECURITY MONITORING,” which is hereby incorporated by reference.

### TECHNICAL FIELD

The embodiments disclosed herein generally relate to personal security systems and more specifically to automated systems for monitoring, reporting, and responding to personal safety conditions through user-defined rules, safe words, and emergency contact procedures.

### BACKGROUND

In recent decades, advancements in personal safety technology have largely focused on improving location tracking and emergency communication capabilities. Systems like GPS enabled smartphones, wearable tracking devices, and mobile safety apps have enabled users to share their location or request assistance in distress. These developments have improved the general ability of individuals to stay connected and monitored during travel, outdoor activities, or emergencies. However, these systems typically require manual interaction, such as pressing a button or launching an app, which may not be feasible in real-life threatening situations where the user is incapacitated, under duress, or unable to operate their device.

One widely adopted approach involves “panic button” applications or hardware devices, which instantly notify emergency contacts or services when activated. While this provides a fast route to request help, it presumes the user is capable of engaging the device. In scenarios such as abductions, accidents, medical episodes, or instances of coercion, a user may not be in a position to initiate an alert. Even GPS trackers, though useful for locating a user's last known position, lack context about the user's condition, intent, or surrounding circumstances, information that can be critical for timely and accurate assistance.

Another class of safety technologies includes mobile apps offering check-in features, primarily geared toward travelers or employees in remote environments. These allow users to manually confirm their safety at pre-set times. However, these systems often lack flexibility, adaptability, or automation. They do not integrate safe words or event-based triggers, nor do they handle scenarios where no response is received, other than issuing generic escalation alerts. Moreover, many such systems depend heavily on uninterrupted access to a user's mobile device, which may not be reliable during critical incidents.

Law enforcement agencies and public safety organizations have attempted to bridge some of these gaps by recommending safety routines, such as sharing trip details with trusted individuals or maintaining consistent communication schedules. These, however, remain manual and ad hoc processes, susceptible to human error and oversight. There is no comprehensive solution that integrates automated reasoning, personal context, and emergency protocol execution into one coherent framework.

Another critical limitation in existing systems is the absence of user-defined safety logic and content-rich alerts. Current solutions typically offer binary outcomes—either the user is safe or not. They do not facilitate the inclusion of layered personal data such as travel plans, health conditions, vehicle details, or contact histories that could expedite assistance and reduce the burden on first responders. This lack of contextual depth severely undermines the efficacy of existing alert systems in high-risk situations.

Additionally, while several commercial tracking devices offer passive location monitoring, their data is often minimal and isolated from broader personal metadata. Furthermore, attackers or environmental conditions can easily disable or separate users from these devices, rendering them ineffective. Sophisticated adversaries may also recognize and disarm conventional alert apps, especially those accessible via the user's phone or smartwatch, which are easily compromised. Moreover, very few technologies consider post-event implications where the user may be permanently incapacitated or deceased. While cloud-based storage or legal document vaults exist, they do not tie into real-time alert systems or offer conditional data releases triggered by the user's prolonged inactivity or confirmed harm. This results in lost opportunities to share vital personal, legal, or financial data at the time it is most needed by family members or authorities.

The commercial marketplace for personal security solutions remains fragmented and predominantly reactive. There is no widely adopted system offering proactive safety event detection, multi-channel communications, safe word integration, and emergency content dispatching. The reliance on user interaction, rather than automated behavioral logic, continues to be a significant bottleneck in the efficacy of personal safety systems.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provide a method and system for a personal safety monitoring and alerting system enables automated check-ins and emergency notifications based on user-defined rules, safe words, and event triggers. The system comprises a user interface for configuring safety parameters, a monitoring engine that evaluates scheduled or real-time events, and a communications module for sending and receiving safety status messages via SMS, email, or other channels. A response analyzer detects safe words or lack of response, prompting an alert system to transmit emergency messages containing the user's contextual data, including medical information, travel plans, personal identifiers, and designated contact details. The system may further include functionality for post-event data transmission, administrative monitoring, and rule based escalation, enhancing personal security and emergency response capabilities.

The present embodiments provide a system for personal safety monitoring and alerting, which automates user check-ins and emergency responses using customizable rules, safe words, and contextual data. Unlike traditional safety technologies that require real-time user interaction, this invention enables proactive and autonomous safety management even when a user is incapacitated or otherwise unable to manually request assistance.

One inventive element of the system is the rule-based user interface, which allows individuals to input their emergency contacts, safe words, check-in schedules, and personal information such as medical history, travel plans, and social connections. This front-end configuration tool forms the foundation for a fully personalized safety experience, tailoring the system's behavior to the user's daily life, preferences, and risk factors. This contrasts with conventional safety apps that provide only basic scheduling or geolocation settings without rich data or multi-variable rule logic.

Another key component is the monitoring engine, which actively evaluates event triggers and scheduled safety rules. It enables the system to initiate safety check-ins based on user-defined events, such as travel plans, appointments, or even geofencing zones. Prior art systems typically rely on fixed or recurring timers for check-ins, offering little flexibility for dynamic or context based events. The inventive monitoring engine can adapt in real-time, offering a more intelligent and responsive user safety model.

The communications module includes multi-channel message delivery and response capture system. By supporting both SMS and email, and optionally other platforms such as push notifications, the system ensures redundancy and accessibility regardless of location or internet status. Many prior solutions rely solely on app-based alerts or mobile push notifications, which are susceptible to app failures, connectivity loss, or OS-level restrictions.

A response analyzer adds a layer of intelligence by scanning incoming user messages for predefined safe words or signs of distress. This goes beyond the binary logic of “safe” or “unsafe” used in other systems, allowing for nuanced detection of emergencies based on user-specific language or codewords. The response analyzer can also interpret non-responses, triggering alerts if the user fails to check in within a designated time frame, an essential capability absent in reactive-only systems.

The alert system provides an automated escalation path by notifying emergency contacts or authorities when safety conditions are violated. Importantly, these alerts are enriched with contextual information defined by the user, including medical conditions, recent travel details, meeting logs, vehicle identifiers, and more. Traditional GPS-based systems may show location, but they cannot convey the user's intent, physical state, or circumstances that led to their disappearance or need for help. The system closes this information gap with a more meaningful and situationally-aware response.

Another feature is the system's ability to customize alert messaging per contact, meaning that family, friends, or authorities may receive different levels of detail or instructions based on their role or proximity to the situation. This targeted notification approach provides better coordination and privacy, avoiding over-disclosure while ensuring appropriate actions are taken by the right recipients.

The system also includes a post-event data release mechanism, commonly referred to as a “digital dead man's switch.” Upon detection of prolonged user inactivity or confirmed harm, critical files or messages can be sent to attorneys, family members, or other trusted parties. This feature introduces a powerful legal and personal security utility that is not found in typical safety monitoring tools. It ensures essential data such as insurance documents, passwords, or instructions are delivered even if the user is incapacitated.

The embodiments further provide an administrative dashboard, where privileged users or authorized entities can monitor system status, intervene when necessary, and audit alert history. This is particularly useful for organizational use in professional settings, such as for employees in field operations, corporate travel, or remote healthcare scenarios. Prior art does not typically allow third-party real-time intervention or transparency into the system's ongoing operations.

In another aspect, the system supports location enhancement features, using external GPS data or third-party location services to provide real-time or last-known coordinates. However, unlike traditional tracking tools that focus solely on physical location, this system correlates movement data with contextual user events, giving a much clearer picture of the user's safety trajectory.

The embodiments also incorporate pattern-matching logic and fuzzy recognition within its safe word processing engine, helping it identify similar or mis-typed distress keywords. This adds robustness and increases the chances of detecting real emergencies, even under high-stress or constrained typing conditions. Most legacy systems require exact string matches, which are error-prone and easily circumvented.

Further enhancing system intelligence is the ability to define multi-tier escalation logic, where safety violations may first notify primary contacts, and then, if unresolved, alert additional stakeholders or authorities. This graduated response reduces false alarms while preserving the system's effectiveness during real emergencies. Prior systems often lack this hierarchical design, resulting in either under-response or over-escalation.

The embodiments also support integration with external systems, such as calendar apps or travel booking services. This allows for automatic rule activation based on calendar events, scheduled meetings, or travel reservations, providing a seamless and intelligent automation experience. Existing technologies typically require users to manually enable or disable alerts.

Another benefit is the ability to log interactions and alert histories securely, forming a digital audit trail that may prove useful for law enforcement, healthcare providers, or legal proceedings. This data integrity aspect is vital in assessing timelines, validating actions taken, and reconstructing events.

The system also supports remote identity verification, ensuring that only the authorized user can dismiss or modify safety check-ins. This reduces the risk of tampering or suppression of alerts in the event that an attacker gains physical access to the user's device.

From a user experience standpoint, the system is designed to offer minimal visibility on mobile devices, making it less detectable by bad actors. While traditional safety apps are often highly visible and easy to disable, this system provides silent operation modes and administrative control to preserve its stealth utility.

In yet another embodiment, the system enables real-time monitoring for specific populations, such as elderly individuals, solo travelers, or at-risk professionals. By offering high configurability, it serves a broader demographic than niche-focused tools that are limited to specific use cases, such as lone-worker monitoring.

Finally, the embodiments introduce a trust-based file release system, wherein critical information is withheld until one or more user-defined conditions are met. This conditional access to sensitive data is particularly useful for estate planning, whistleblower protection, or sensitive business communications.

Taken together, these features demonstrate a significant advancement over existing personal security and alerting technologies. By enabling proactive, intelligent, and context-rich automation, the invention transforms how individuals manage their personal safety, bridging critical gaps in prior art and offering meaningful new capabilities tailored for real-world risks.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a computer system architecture, according to some embodiments;

FIG. 2 illustrates a block diagram of an application program in operable communication with the computer system, according to some embodiments; and

FIG. 3 illustrates a flowchart of a method for automated personal security monitoring, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a personal safety monitoring and alerting system enables automated check-ins and emergency notifications based on user-defined rules, safe words, and event triggers. The system comprises a user interface for configuring safety parameters, a monitoring engine that evaluates scheduled or real-time events, and a communications module for sending and receiving safety status messages via SMS, email, or other channels. A response analyzer detects safe words or lack of response, prompting an alert system to transmit emergency messages containing the user's contextual data, including medical information, travel plans, personal identifiers, and designated contact details. The system may further include functionality for post-event data transmission, administrative monitoring, and rule based escalation, enhancing personal security and emergency response capabilities.

The rule-based user interface (UI) serves as the central access point where users configure the behavior of the personal safety system. Upon account creation, users are guided through a secure registration process where they input basic personal data, such as name, age, contact information, and health-related details. The UI is accessible via a secure web application, and optionally through a limited-access mobile app.

Through the interface, users can define one or more safety “rules” that trigger monitoring actions. These rules may include scheduled check-ins, such as “every day at 6 p.m.,” event-based rules, like “start tracking when I enter a rideshare,” or geolocation rules, such as “activate alerts if I leave a certain radius.” The rule builder supports conditional logic using dropdowns or natural language inputs, making it easy for non-technical users to set up their own safety routines.

Users can also create safe words, which are specific keywords or phrases that silently trigger emergency actions when included in a check-in response. This empowers individuals to discreetly signal distress without alerting potential attackers or bystanders. Safe words can be general or tied to specific rules or contacts for added flexibility.

Additionally, the UI allows users to input emergency contact details, including phone numbers and email addresses of friends, family, or authorities. Each contact can be assigned specific permissions or roles, which play into features like multi-tier escalation and customized messaging. The interface supports recurring rules, one-time events, and batch imports for more complex or repetitive use cases.

The monitoring engine functions as the operational core of the system, continuously evaluating user-defined rules to determine when to initiate safety check-ins. It runs as a background service, checking time-based triggers, event flags, or external data, such as geolocation or calendar updates, to determine which rules should be activated.

When a trigger is met, the engine generates a safety check-in prompt and queues it for dispatch through the communications module. It marks the related event as active, monitors the time window for user responses, and logs relevant metadata for later use. The engine is capable of handling multiple concurrent events and adapting to real-time changes in user behavior or schedule.

The engine also connects with third-party data sources to enhance automation, pulling information from calendars, travel bookings, or appointment systems. This allows users to set up fewer manual events while still ensuring accurate and relevant safety prompts. Once an event window ends, the engine marks the rule as completed or violated, depending on the user's response.

To prevent confusion, the engine can detect overlapping or conflicting rules and resolve them intelligently. For example, if two rules are scheduled at the same time, it will prioritize the one with the higher alert level or combine both sets of conditions as needed.

The communications module handles all message delivery and reception within the system.

It supports multiple channels, including SMS, email, and optionally mobile push notifications. Each outgoing message asks the user to confirm their safety, either by replying with a specific response or a free-form message that the system can interpret.

To improve reliability, the module can fall back on secondary channels if the primary one fails. For example, if a text message fails to deliver, the system may send an email instead.

Responses are timestamped and passed along to the response analyzer for evaluation.

Messages sent by the system are designed to appear ordinary, especially on mobile devices. This ensures that in a hostile or stressful situation, messages will not appear suspicious to anyone looking at the user's phone. Emergency alerts are handled differently, containing full information for the contacts receiving them.

The module also supports two-way communication. Emergency contacts can reply to confirm receipt or update the system with follow-up actions. This helps close the loop and ensures that alerts lead to real-world responses.

The response analyzer interprets incoming messages and determines whether the user's safety status is confirmed or compromised. It scans for safe words, context clues, and timing gaps. If a safe word is found or the user does not respond in time, it flags the situation and triggers the alert system.

The analyzer uses fuzzy recognition and natural language matching to catch variations of safe words. This allows the system to detect distress signals even if the user misspells the word or hides it inside a longer sentence. This level of intelligence helps protect users in situations where communication may be rushed or constrained.

The system also looks for signs of deception or coercion. If a response includes an “I'm fine” message but subtly inserts a safe word, the analyzer will still recognize it as a red flag. Each response is stored along with metadata such as timestamp, channel used, and confidence level in the analysis.

The alert system is responsible for notifying emergency contacts when a safety violation occurs. Once triggered by the response analyzer, it compiles the user's relevant data and sends messages through email, SMS, or other channels.

These alerts can include personal health information, travel history, social connections, and last known location. The system is designed to provide enough context for emergency contacts to act quickly and effectively, even if they do not know the user's exact plans.

The alert system also tracks which contacts have acknowledged the alert. If a message is not acknowledged within a set timeframe, the system automatically escalates to additional contacts or law enforcement, depending on how the user configured the alert chain.

Post-incident summaries are created automatically, which may be used later by family, attorneys, or authorities to understand what happened and how the system responded.

Each emergency contact can receive a different version of the alert message, tailored to their role and level of trust. For example, a close friend might receive medical information and travel history, while a work contact might only get location and basic details.

Templates are used to format these messages, and they pull in real-time data from the user's profile and check-in history. This helps ensure that contacts receive only the information they need and are not overwhelmed with irrelevant or overly sensitive details.

Users can define these templates in advance and assign them to specific contacts through the rule-based UI. This level of customization provides more control, better privacy, and a stronger chance of getting help from the right people.

The administrative dashboard allows designated individuals or organizations to monitor safety events in real time. It can be used by family members, caregivers, employers, or even community groups that coordinate safety for vulnerable populations.

Through the dashboard, users with access can view live status updates, check rule logs, and receive alerts when a safety check-in is missed. They can also manually intervene if needed, such as by marking someone safe or triggering an alert on their behalf.

All actions taken in the dashboard are logged and traceable. This ensures that interventions are secure and that the system's operation can be audited later if necessary.

The system can gather the user's location from mobile GPS, external services like Life360, or other connected devices. If a device reports location, the system will include it in outgoing alerts and use it for geofencing logic in the monitoring engine.

However, the system is also designed to work without location data. If GPS is unavailable, it falls back on last known events, scheduled activities, or contact histories to estimate location and travel direction.

This hybrid model avoids relying on a single data point that can be disabled or tampered with. It ensures continuity in alert coverage even when GPS tracking is compromised.

To reduce false negatives, the system includes advanced matching logic that looks beyond exact safe word matches. It recognizes similar words, common misspellings, and phonetic variants. This feature is especially important in high-stress situations where users may be unable to type correctly. By allowing more flexible interpretation, the system increases its chances of detecting real emergencies.

It also lets users define multiple safe words or code phrases that can work in different contexts, improving usability across different languages or personal preferences.

The system does not rely on a single alert path. Instead, it follows a tiered structure where contacts are grouped based on urgency. For example, Tier I might include close family, while Tier 2 could be extended family or neighbors, and Tier 3 could include law enforcement or legal contacts.

If no one in the first tier responds, the system moves to the next. This reduces unnecessary panic while still ensuring that help arrives if needed. Each tier can have different templates and rules associated with it.

This method adds structure to the alert system and gives users control over how and when their network is engaged during a crisis.

To improve automation, the system can connect to other platforms. For example, calendar integrations allow the system to set up rules based on scheduled events. If a user has a flight booked, a travel rule can activate automatically.

These integrations also make it easier to keep the system updated without requiring constant manual input. The system pulls in fresh data as needed, keeping rules accurate and timely. Connections to services like rideshare apps or hotel bookings allow alerts to contain more accurate data, which helps responders act more effectively.

Every event, response, and system action is logged in a secure record. These logs include timestamps, contact details, and message contents.

The logs can be used for review, legal purposes, or accountability after an incident. They are encrypted and stored securely to protect user privacy.

Users or administrators can export logs or share them with trusted individuals, such as legal counsel or medical staff, when needed.

The system is designed to serve not just individuals but also groups who face higher safety risks. Seniors living alone, domestic violence survivors, and employees in isolated or high-risk jobs can all benefit from its features.

Organizations can manage multiple users through a shared interface. This allows teams to monitor safety check-ins, respond to alerts, and ensure everyone in the group is accounted for.

Group-based settings can be tailored for different populations, ensuring the system remains user-friendly and relevant across many use cases.

If a user is incapacitated or confirmed to be in danger for a prolonged period, the system can release important documents to pre-approved contacts. This may include legal documents, personal messages, or instructions.

Users define the release rules in advance, including how long the system must wait before acting and who should receive the files. These files are encrypted and stored securely until the release conditions are met.

This feature gives users peace of mind and allows them to prepare for worst-case scenarios with confidence and control.

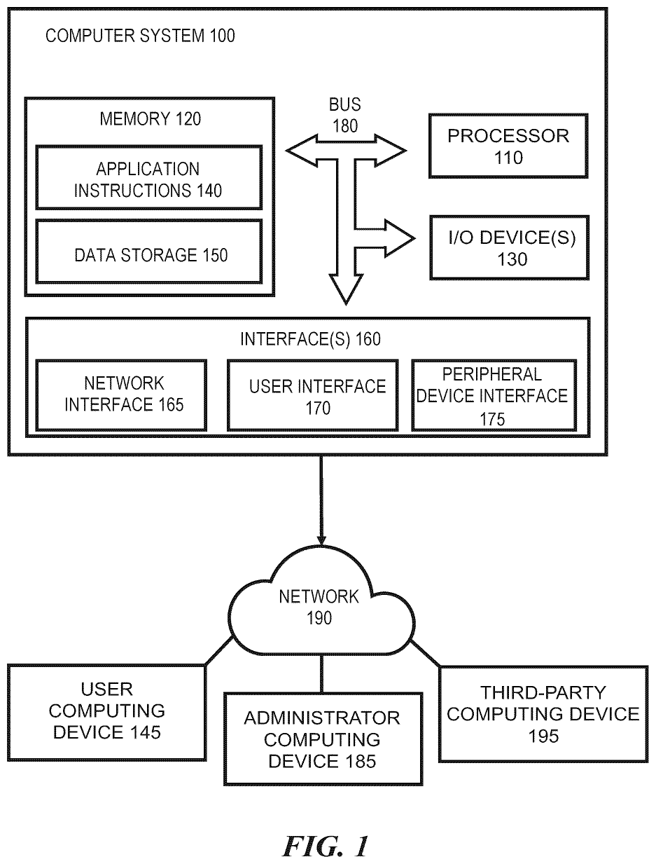

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component

Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum dot based transistors, switches, and gates, to optimize space usage or enhance performance of user equipment. A processor can also be implemented as a combination of computing processing units. In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C#, JAVA, JAVASCRIPT, PERL, etc.).

In this disclosure, terms “store, storage, data store,” data storage, database,” and substantially any other information storage component relevant to operation and functionality of a component are utilized to refer to “memory components,” which are entities embodied in a ‘memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. Hosting platforms may be implemented including public or private clouds. Further, various cloud storage system including table storage, blob storage databases, etc. may be used. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANS, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g. the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

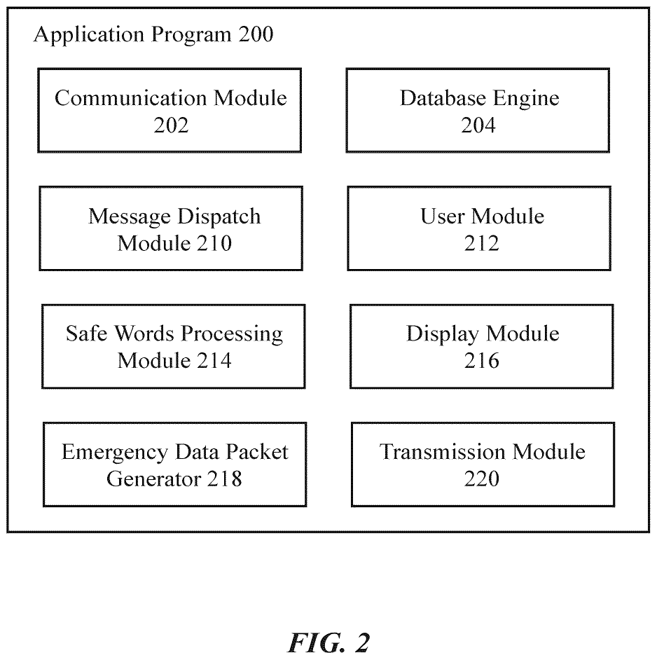

FIG. 2 illustrates an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a message dispatch module 210, a user module 212, a safe words processing module 214, a display module 216, an emergency data packet generator 218, and a transmission module 220.

In some embodiments, the communication module 202 is configured for receiving, processing, and transmitting a user command and/or one or more data streams. In such embodiments, the communication module 202 performs communication functions between various devices, including the user computing device 145, the administrator computing device 185 and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195.

In some embodiments, the communication module 202 may be in operable communication with the transmission module 202 to send the emergency data packet to selected recipients upon safe word detection or user inactivity.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

In some embodiments, the message dispatch module 210 is configured to deliver safety check-in prompts and receive user responses and may be facilitated by the communication and transmission modules.

In some embodiments, the user module 212 facilitates the creation of a user account for the application system. The user module 212 may allow the user to create a user profile which a means for verifying the user, establishing user permissions and assigning a role to the user.

In some embodiments, the safe words processing module 214 is in operable communication with the computing device to parse incoming messages for predefines safe words or keywords.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored.

In some embodiments, the emergency data packet generator 218 is configured to compute a user's contextual information including medical, travel, and identification data.

In some embodiments, the transmission module 220 is configured to send the emergency data packet to selected recipients upon safe word detection or user inactivity.

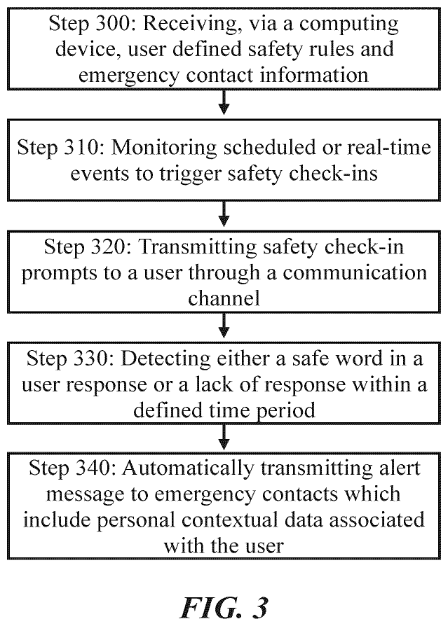

FIG. 3 illustrates a flowchart illustrating an embodiment of a method for automated personal safety alerting. The method begins at Step 300, where a computing system receives user defined safety rules and emergency contact information through a user interface. These rules may include recurring check-ins, single-use event triggers, geofencing conditions, or custom logic specified by the user.

In Step 310, the system continuously monitors for scheduled or real-time events that would initiate a safety check-in. This monitoring may include the evaluation of calendar data, GPS boundaries, known travel plans, or contextual environmental inputs. Upon determining that a safety event should be activated, the process proceeds to Step 320.

At Step 320, the system transmits a safety check-in prompt to the user via a communication channel such as SMS, email, or push notification. The message may request confirmation of safety status and include a time window for response.

The system then awaits a user response. Upon receipt, the system verifies the identity of the user to ensure the response is authentic. This may include multifactor checks or device fingerprinting. If the identity cannot be verified, the process proceeds directly to alert escalation.

In Step 330, the system evaluates whether the response includes a safeword or whether no response was received within the expected timeframe. If either condition is met, the method proceeds to Step 340, where alert messages are automatically generated and transmitted. The system compiles an alert containing contextual user data. This may include personal identifiers, medical data, travel itineraries, last known user interactions, and any files or digital assets the user has designated for release in case of emergency. The alert format is customized per recipient. Next, the alert messages are transmitted to emergency contacts. The system supports multi-tier escalation and customized message templates based on the contact's assigned role.

Following alert transmission, the system records the interaction in a secure audit log. This includes timestamps, message content, contact acknowledgment, and event results.

Finally, the system waits for acknowledgment from emergency contacts. If a response is received, the system may log it and conclude the alert sequence. If no acknowledgment is received within a predetermined window, the system escalates to a secondary set of contacts or authorities.

In this disclosure, the various embodiments are described with reference to the flowchart illustrations and/or block diagrams of methods, apparatus (systems), and computer program products.

Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

In the context of the present invention, the API, third-party, or operating system components may be used to receive information associated with the user such as the user's calendar information, location, or other data.

The phrase “central processing unit” as is used herein means a computer hardware component that executes individual commands of a computer software program. It reads program instructions from a main or secondary memory and then executes the instructions one at a time until the program ends. During execution, the program may display information to an output device such as a monitor. In the context of the present invention, the CPU may be used to execute various processes and functions described hereinabove.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A personal safety monitoring system, comprising:
at least one user computing device in operable connection with a user network; an application server in operable communication with the user network, the application server configured to host an application program for providing a personal safety monitoring system, the application program in operable communication with one or more processors coupled to a memory, wherein the processor in operable communication with:
a user interface configured to receive user input including emergency contact information, one or more safe words, one or more safety check-in rules, and a plurality of personal data; a monitoring engine configured to initiate safety check-in requests to a user based on predefined rules or event triggers; a communication module configured to transmit the check-in requests and receive response messages from the user via at least one communication channel, a response analyzer configured to detect safe words or non-responsiveness in received messages; and an alert system configured to notify one or more emergency contacts with preselected user data in response to a detected safe word or absence of response within a predefined time window.

2. The system of claim 1, wherein the user input further includes at least one of medical information, travel itinerary, social contacts, or biometric identifiers.

3. The system of claim 1, wherein the communication module includes encryption for secure transmission of safety prompts and response messages.

4. The system of claim 1, further comprising an administrative interface configured to allow authorized third parties to monitor system status and assist in emergency response.

5. The system of claim 1, wherein the response analyzer is configured to identify partial safe word matches using fuzzy logic or pattern recognition.

6. The system of claim 1, wherein the alert system is further configured to send geographic location data obtained from the user's device or an external GPS service.

7. The system of claim 1, wherein the alert system is configured to send different messages to different emergency contacts based on user-defined roles or tiers.

8. The system of claim 1, wherein the system is further configured to store and later transmit personal digital assets or files to designated recipients based on inactivity or detected harm.

9. The system of claim 1, wherein the monitoring engine is further configured to integrate with third-party calendar or scheduling tools to generate dynamic check-in schedules.

10. The system of claim 1, wherein the communications module supports delivery and receipt of messages via mobile applications or push notifications in addition to SMS and email.

11. A method for automated personal safety alerting, the method comprising the steps of:
receiving, via a computing system, user defined safety rules and emergency contact information; monitoring scheduled or real-time events to trigger safety check-ins; transmitting safety check-in prompts to a user through a communication channel;
detecting either a safe word in a user response or a lack of response within a defined time period; and automatically transmitting alert messages to emergency contacts, the alert messages including personal contextual data associated with the user.

12. The method of claim 11, further comprising verifying the identity of the user before accepting any response to a check-in request.

13. The method of claim 11, further comprising storing a log of user interactions and alert transmissions in a secure audit log.

14. The method of claim 11, wherein the step of monitoring includes tracking geofenced boundaries or physical travel routes.

15. The method of claim 11, wherein the alert messages are formatted to include contextual event details, last known user interactions, and relevant file attachments.

16. The method of claim 11, wherein user-defined safety rules include recurring schedules, single-use events, and user-customizable conditions.

17. The method of claim 11, further comprising the step of allowing emergency contacts to acknowledge receipt of the alert and confirm their response status.

18. A computer-implemented system for managing personal safety notifications, the
system comprising:
a rule-based engine configured to evaluate user-defined temporal and conditional safety parameters; a message dispatch module for delivering safety check-in prompts and receiving user responses;
a safe words processing module configured to parse incoming messages for predefined safe words or keywords; an emergency data packet generator configured to compute a user's contextual information including medical, travel, and identification data; a transmission module configured to send the emergency data packet to selected recipients upon safe word detection or user inactivity.

19. The system of claim 18, wherein the emergency data packet includes credentials for user-owned accounts such as rideshare apps, hotel reservations, or dating platforms.

20. The system of claim 18, wherein the rule-based engine is further configured to escalate alerts from low-priority to high-priority contacts based on elapsed response times.
